(19) United States
(12) Patent Application Publication
(10) Pub. No.: US 2007/0273551 A1
(43) Pub. Date: Nov. 29, 2007

(54) Advanced warning system for emergency vehicles

(76) Inventors: Royce A. Jacobs, (US); Carol N. Green, (US)

Correspondence Address: CAROLN. GREEN, ESQ., SUITE 2750, 200 S. BISCAYNE BLVD., MIAMI, FL, 33131, US

(21) Appl. No.: 11/805,495

(22) Filed: May 22, 2007

Related U.S. Application Data
(60) Provisional application No. 60/802,966, filed on May 24, 2006.

(51) Int. Cl. G08G 1/00; G08G 1/123

(52) U.S. Cl. 340/902; 340/988

(57) ABSTRACT

An advanced warning system that will alert motorists of an approaching emergency vehicle to provide motorists with ample time to yield the right of way and clear a path for the emergency vehicle, thereby drastically reducing the emergency vehicle's response time.

### PRIORITY CLAIM

The present application is a regular Non-Provisional Patent Application claiming priority to U.S. Patent Application, Advanced Warning System For Emergency Vehicles, Ser. No.: 60/802,966 filed May 24, 2006 and the entire disclosure of the Provisional Application Ser. No.: 60/802,966 is incorporated herein by reference.

### FIELD OF THE INVENTION

The disclosed invention is directed to an advanced warning system for emergency vehicles, which allows motorists in the path of an emergency vehicle to be forewarned of an emergency vehicle's impending approach well in advance through an early warning system, preferably installed in the non-emergency vehicle's dashboard, involving flashing red or yellow lights and/or a voice command system.

### BACKGROUND OF THE INVENTION

Time is of the essence when it comes to an emergency situation. The sooner an emergency vehicle arrives at the scene of an emergency, the sooner emergency personnel can render aid to an individual in need. Emergencies such as, but not limited to, strokes and fires, demand a rapid response because the sooner assistance is given, the less severe the damage from the stroke or fire will be. There are some emergency vehicles that can respond rapidly, for example helicopters. Unfortunately, the use of helicopters to respond to all emergencies is not only impractical but they are also costly. Besides, ambulances, fire engines and police cars or motorbikes are more available and have greater accessibility to confined spaces than helicopters.

Oftentimes the response time for emergency vehicles are further delayed by vehicular congestion on the roads, especially during rush hour. Although, motorists are aware that they need to clear a path for the emergency vehicle they may not be able to do so because of the congestion. With the present invention, non-emergency vehicles in the path of emergency vehicles can be forewarned of an emergency vehicle's approach and have the opportunity to provide clearance well in advance of the emergency vehicle's approach.

Currently, motorists are alerted to emergency vehicles by the sirens and flashing lights. However, it is not uncommon for motorists to be distracted by their cell phones, DVD players, radio and/or other audiovisual equipment installed in their cars, and as such, they are unaware of the emergency vehicle's imminent approach until the very last minute. In that situation, several motorists respond by panicking and driving frantically in several different directions at once which occasionally creates a zigzag path for the emergency vehicle driver causing additional road hazards and sometimes even accidents.

Thus, there is a need for emergency vehicles, such as, but not limited to, ambulances, fire engines, police cars or motorbikes, to have the ease of maneuverability of helicopters and the accessibility to different locations without the added cost. An advanced warning system for emergency vehicles will satisfy that need as it necessarily produces a shorter response time by having motorists yield for emergency vehicles early enough to provide a clear unobstructed path. Police cars or motorbikes will be able to get to the scene of the accident or crime earlier, ambulances will be able to reach their patients faster, and fire engines will be able to respond to fires faster.

An additional benefit of an advanced early warning system is that motorists of equipped and non-equipped vehicles can benefit from the invention. With an advanced early warning system, motorists are alerted early enough to create a shortened response time providing clearance for the emergency vehicle in an orderly manner. Vehicles that are not equipped with the advanced warning system will continue to be warned of the approach of an impending emergency vehicle in the traditional manner by hearing the emergency vehicle's sirens and the flashing lights. Unequipped vehicles will also see vehicles that are equipped with the advanced warning system providing clearance and will be able to move accordingly providing a clear path prior to hearing the sirens or seeing the flashing lights.

### SUMMARY OF THE INVENTION

Generally, the objective of this present invention is to provide an advanced warning system that will alert motorists of an approaching emergency vehicle to provide motorists with ample time to yield the right of way and clear a path for the emergency vehicle, thereby drastically reducing the emergency vehicle's response time. The present invention comprises of two major components—a transmitter and a receiver component (also referred to herein as the “Interface Module”). The transmitter component comprises of transmitting means; a signal generating means, an alarm generating means and a location determining means. The transmitter component may generally comprise of a software component or a combination of both hardware and software components that may be hosted on a computer at the area of dispatch or on an electronic communication device within the emergency vehicle. In an alternate embodiment of the invention, the transmitter component is hosted at the area of dispatch, i.e. at the hospital, police or fire station versus in the emergency vehicle.

The Interface Module or receiver component comprises of receiving means for receiving generated signals and a second signal generating means in communication with the transmitter component of the invention.

Another objective of the present invention is to provide a system for determining the location of non-emergency vehicles such that it can accurately transmit the appropriate alarm signal.

The present invention relates generally to an advanced warning system for emergency vehicles. More specifically, the invention provides early warning and detection of responding emergency vehicles to non-emergency vehicles located within a 360-degree radius or vicinity. Once the advanced warning system for emergency vehicles has been activated, it will transmit information concerning the location of the emergency to a Global Position System (“GPS”) that in turn maps out the fastest route for the responding emergency vehicle.

Each non-emergency vehicle that is equipped with the advanced warning system for emergency vehicles will host an Interface Module. The Interface Module comprises of software and/or hardware components that are capable of communicating with the transmitter component. In some embodiments of the invention, depending on the make and model of the vehicle, the Interface Module may comprise solely of a software component with the combined capabilities of both the software and hardware component. The advanced warning system for emergency vehicles will automatically poll non-emergency vehicles equipped with a corresponding Interface Module that are within a 360-degree radius and are en route to the emergency to verify if the non-emergency vehicle is moving or parked.

Once polled, the Interface Module responds with a return signal notifying the transmitter component of the non-emergency vehicle's state of motion. If the non-emergency vehicle is parked, the vehicle is ignored and no further signals are transmitted. If the non-emergency vehicle is in motion, the Interface Module generates a signal triggering either a visual and/or an audiovisual alarm. The non-emergency vehicles now have ample time to make the necessary adjustments to provide a clear and unobstructed path for the responding emergency vehicle. Unequipped vehicles can also follow suit based on the movement of the equipped non-emergency vehicles. This facilitates a faster response to emergencies, which can save lives.

The advanced warning system for emergency vehicles further comprises of location determining means to detect the non-emergency vehicle's distance (“d”) from the responding emergency vehicle. If d is within a certain radius or distance away, e.g. half of a mile, the non-emergency vehicle's alarm will flash yellow. However, as d decreases, e.g. one quarter of a mile, or in instances where the non-emergency vehicle is already within or enters a certain radius, the non-emergency vehicle's alarm will instead flash red. In non-emergency vehicles that are equipped with the invention, the alarm will interrupt all radio, DVD and CD transmissions to broadcast a corresponding message, e.g. “WARNING, EMERGENCY VEHCILE IS APPROACHING,” or similar words to that effect. It is understood by those skilled in the art that the audiovisual alarm is capable of being programmed in different languages as needed. Once the emergency vehicle has left the vicinity and is a safe distance away, e.g., one eight of a mile from the non-emergency vehicle, the non-emergency vehicle's visual and/or audiovisual alarm will cease.

In an alternative embodiment of the invention, both a fire station and a hospital receive notification of a fire that will require emergency rescue and assistance. Upon receipt of notification of the emergency, both emergency personnel in the two different locations activate the transmitter component of the system inputting the location of the fire. The transmitter component will transmit a signal to a GPS which maps out the fastest route for both the fire truck and the ambulance regardless of whether or not they are in the same area of the city. The transmitter component then sends a request signal to all moving non-emergency vehicles that are detected to have the Interface Module installed. The advanced warning system for emergency vehicles verifies that these vehicles are in motion and if they are, it will confirm their distance away from the emergency vehicle en route to the fire and will trigger the non-emergency vehicle's alarm to flash the appropriate alarm color depending on the distance. In this embodiment, the emergency vehicles may be located in two separate quadrants of the city. Thus, motorists in both sections of the city will be alerted simultaneously to clear a path for the respective emergency vehicle.

For a further and more fully detailed understanding of the present invention, various objects and advantages thereof, reference is made to the following detailed description and the accompanying drawings.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIG. 1 is a schematic illustration of the elements and entities involved in the emergency response system in accordance with an exemplary embodiment of the present invention.

FIG. 2 is a flow chart illustrating the tasks performed by the advanced warning system for emergency vehicles 100 as it involves a response to an emergency.

### DESCRIPTION OF PREFERRED EMBODIMENTS

The present invention is now described in more detail by reference to the exemplary drawings in detail wherein like numerals indicate like elements throughout the various views. This is for convenience only and is not intended to limit the application of the present invention. In fact, after reading the following description, it will be apparent to one skilled in the relevant art(s) how to implement the following invention in alternate embodiments.

The present invention comprises of two major components—transmitter component 10 and an Interface Module 22. The transmitter component 10 further comprises of transmitting means 102 for transmitting and receiving information to or from satellites and or other communication devices; a signal generation means 104 for generating signals; an alarm generating means 106 for activating and controlling alarms in non-emergency vehicles equipped with the Interface Module 22; and a location determining means 108 for determining the location of non-emergency vehicles. In one embodiment of the invention, the location determining means 108 may determine the location of non-emergency vehicles relative to the emergency. In an alternate embodiment of the invention, the location determining means 108 may determine the location of non-emergency vehicles relative to the emergency vehicle. These elements of the transmitter component 10 may be in communication with each other in a variety of ways known to those of ordinary skill in the art including, but not limited to, wireless connections. The Interface Module 22 comprises of receiving means 24 for receiving generated signals and a second signal generation means 26 for generating and relaying signals to the transmitter component 10 of the invention.

Generally, in the case of an emergency, the authorities are first notified by a telephone call through a 911 operator. Depending on the type of emergency, the 911 operator will determine whether a fire truck, police, ambulance or some combination thereof, will be the appropriate response and will route the request for emergency services accordingly.

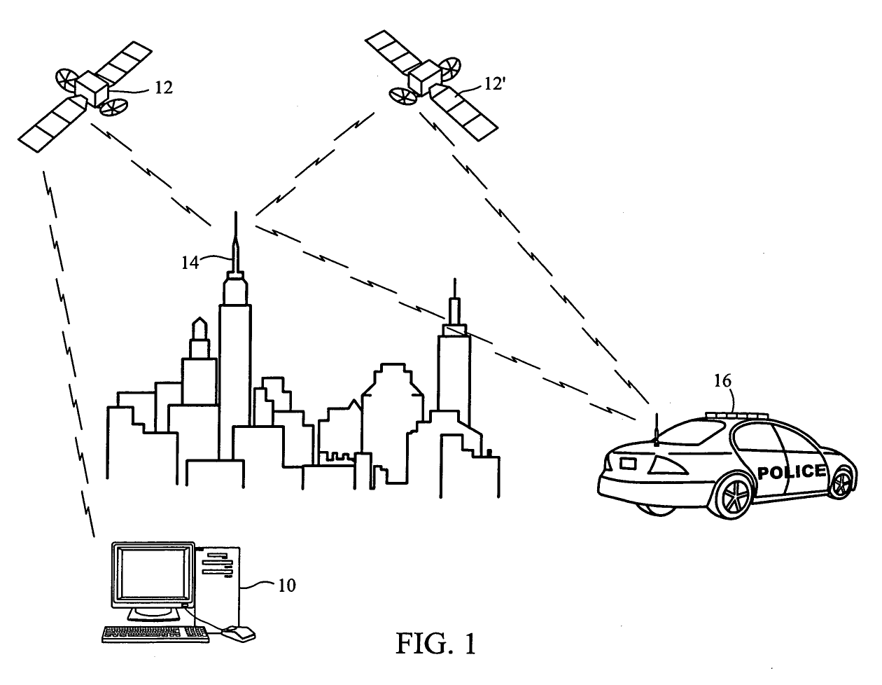

FIG. 1 is a schematic illustration of the elements and entities involved in the emergency response system in accordance with an exemplary embodiment of the present invention. As seen in FIG. 1, once the advanced warning system for emergency vehicles 100 receives information concerning the location and nature of the emergency, i.e. fire, crime or health incident, the transmitter component 10 of the system transmits that information to a GPS satellite system 12, 12′.

The GPS receivers 13 (not shown) in combination with GPS satellite system 12, 12′ receives the transmitted information and use triangulation to calculate inter alia, the emergency response team's precise location, distance to the destination location, i.e. the emergency site, and the fastest route to the emergency. In urban areas, emergency response teams would most likely rely on Differential GPS (DGPS) to provide signal correction in areas with several skyscrapers as the DGPS receivers are much more accurate than ordinary receivers.

As seen in FIG. 1, the GPS satellite system 12, 12′ broadcasts the GPS signal to a ground receiver 14, which interprets the data and transmits the information to a GPS receiver in the emergency vehicle 16 that displays the data on an electronic map 18 (not shown). As is well known and used in the art, many GPS receivers that are installed in motorvehicles are equipped with an audio component providing the driver with precise and detailed audible navigational instructions to the destination location.

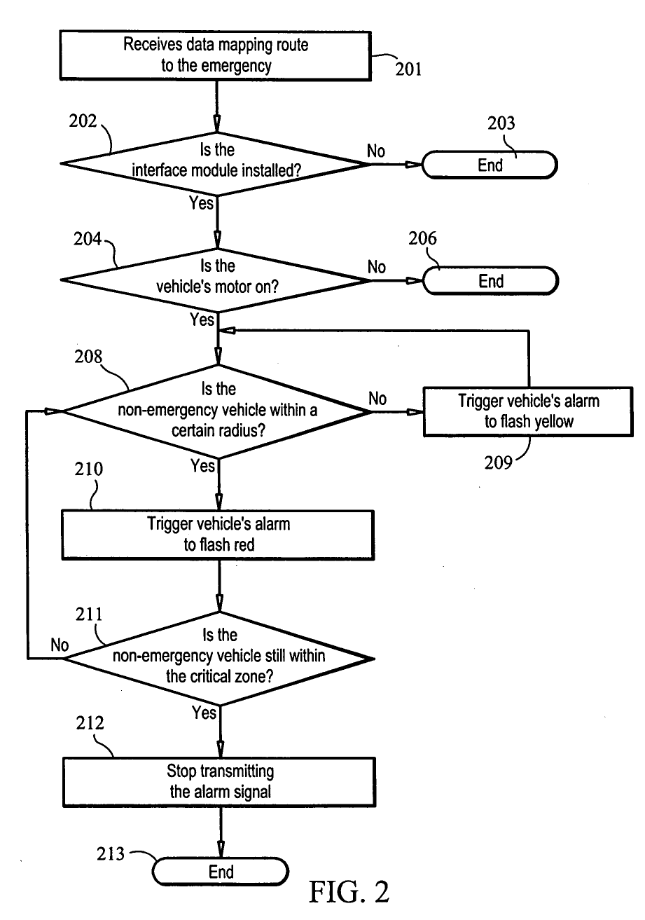

FIG. 2 is a flow chart illustrating the tasks performed by the advanced warning system for emergency vehicles 100 as it involves a response to an emergency. Once the advanced warning system for emergency vehicles 100 receives data from the GPS satellite system 12, 12′ mapping the route to the emergency as shown in Step 201, using the signal generating means 104, the transmitter component 10 generates a first request signal that automatically polls non-emergency vehicles within a certain radius or distance detected to be en route to the emergency, to confirm whether or not the non-emergency vehicle has the corresponding Interface Module 22 of the invention installed as shown in Step 202.

If the non-emergency vehicle is not equipped with the Interface Module 22 of the invention, then the transmitter component 10 of the system ignores that vehicle and no further signals or requests will be issued to that non-emergency vehicle as in Step 203. However, the transmitter component 10 of the invention will continue to poll all other vehicles within the specified radius and/or distance for similar information (Step not shown).

In the alternative, if the non-emergency vehicle is equipped with the Interface Module 22, the transmitter component 10 of the system, using the signal generating means 104, issues a second signal to the receiving means 24 of the Interface Module 22 of the non-emergency vehicle which receives the signal. The transmitter component 10 checks to see if the non-emergency vehicle is moving or parked by inquiring whether the non-emergency vehicle's motor is on as in Step 204 or off. If the individual vehicle's motor is off, the second signal generating means 26 of the Interface Module 22 will generate and relay a signal to the transmitter component 10 notifying the transmitter component 10 that the vehicle's motor is off as in Step 205 (not shown). Additionally, that non-emergency vehicle is ignored, and no further signals will be transmitted as in Step 206 to that non-emergency vehicle. If the non-emergency vehicle's motor is on, the second signal generation means 26 of the Interface Module 22 of the non-emergency vehicles will relay an additional signal confirming that the non-emergency vehicle is in motion to the transmitter component 10 as in Step 207 (not shown).

Once the transmitter component 10 receives confirmation from the second signal generation means 26 of the Interface Module 22 that the non-emergency vehicle is in motion, the location determining means 108 transmits a signal requesting verification from the Interface Module 22 that the non-emergency vehicle is within a certain prescribed radius and/or distance (Step 208) away from the emergency vehicle.

If the location determining means 108 detects that the non-emergency vehicle is within a certain prescribed range and/or radius from the emergency vehicle, e.g. half of a mile away, the alarm generating means 106 will trigger the non-emergency vehicle's alarm to flash yellow as in Step 209. For non-emergency vehicles equipped with the invention, the audio alarm will interrupt all audible transmissions to broadcast a corresponding warning message, e.g. “EMERGENCY VEHICLE WILL APPROACH SHORTLY” or some other words of similar import and/or content. The location determining means 108 will continue to confirm and verify that the non-emergency vehicle is still within that radius and/or distance by returning to Step 208 until the location determining means 108 is otherwise informed.

If the non-emergency vehicle is within a certain distance or radius that closely approximates imminent approach of the emergency vehicle, i.e. a critical zone, the alarm generating means 106 will trigger the non-emergency vehicle's alarm to flash red as in Step 210. In addition, the alarm will interrupt all audible transmissions to broadcast a command message for e.g. “WARNING, EMERGENCY VEHICLE IS IMMINENTLY APPROACHING” or similar words to that effect as in Step 214 (not shown). Accordingly, the non-emergency vehicle in this critical zone is alerted that there is an emergency vehicle that is imminently approaching. By having an early alert of the approaching emergency vehicle, non-emergency vehicles can create a clear path for the responding emergency vehicle allowing a more rapid response to the emergency.

If the non-emergency vehicle is still within the critical zone the location determining means 108 will return to Step 208 and continue to verify that the non-emergency vehicle is within the prescribed radius or distance and has not moved beyond that radius or distance. As such, the alarm signal is perpetuated until the location determining means 108 is otherwise notified. Once the non-emergency vehicle is outside the critical zone, the alarm generating means will stop transmitting the alarm signals to the non-emergency vehicles as in Step 212 and there will be no further transmissions to that non-emergency vehicle as in Step 213.

What is claimed is:

1. An advanced warning system for emergency vehicles system comprising of:
a. a transmitter component wherein the transmitter component further comprises of:
i. transmitting means for transmitting and receiving information to or from satellites or other communication devices;
ii. a signal generation means for generating signals;
iii. an alarm generating means for activating and controlling alarms in non-emergency vehicles equipped with a receiver component; and
iv. a location determining means for determining the location of non-emergency vehicles;
b. the receiver component wherein the receiver component comprises of:
i. a receiving means for receiving signals from the transmitting component; and
ii. a second signal generation means for relaying signals to the transmitting component.

2. The transmitting component according to claim 1 further comprising of a software component.

3. The transmitting component according to claim 1 further comprising of a hardware component.

4. The transmitting component according to claim 1 further comprising of both software and a hardware component.

5. The system according to claim 1 further comprising transmitting means, in communication with the second signal generation means, for determining information concerning the non-emergency vehicle's motor's status.

6. The system according to claim 1 wherein the location determining means determines the location of the non-emergency vehicle relative to an emergency vehicle.

7. The system according to claim 1 wherein the location determining means determines the location of the non-emergency vehicle relative to an emergency.

8. The system according to claim 1 wherein the alarm generating means is programmable in varied different languages.
